(19) United States
(12) Patent Application Publication
(10) Pub. No.: US 2007/0118696 A1
(43) Pub. Date: May 24, 2007

(54) Register tracking for speculative prefetching

(75) Inventors: Donald W. McCauley, Lakeway, TX (US); Sresth Kumar, Austin, TX (US)

Correspondence Address: INTEL CORPORATION;c/o INTELLEVATE, LLC, P.O. BOX 52050, MINNEAPOLIS, MN, 55402, US

(73) Assignee: Intel Corporation

(21) Appl. No.: 11/286,585

(22) Filed: Nov. 22, 2005

(51) Int. Cl. G06F 12/00

(52) U.S. Cl. 711/137

(57) ABSTRACT

An apparatus and method for prefetching based on register tracking is disclosed. In one embodiment, an apparatus includes a register tracker and a pre-computation engine. The register tracker is to generate a pre-computation slice. The pre-computation engine is to execute the pre-computation slice.

### BACKGROUND

1. Field

The present disclosure pertains to the field of data processing apparatuses and, more specifically, to the field of prefetching data in data processing apparatuses.

2. Description of Related Art

In typical data processing apparatuses, data needed to process an instruction may be stored in a memory. The latency of fetching the data from the memory may add to the time required to process the instruction, thereby decreasing performance. To improve performance, techniques for speculatively fetching data before it may be needed have been developed. Such prefetching techniques involve moving the data closer to the processor in the memory hierarchy, for example, moving data from main system memory to a cache, so that if it is needed to process an instruction, it will be take less time to fetch it.

However, the prefetching of data that is not needed to process an instruction is a waste of time and resources. Therefore, important considerations in the implementation of prefetching include a determination of what data to prefetch and when to prefetch it. For example, one approach is to use prefetch circuitry to identify and store the typical distance (the “stride”) between the addresses of data needed for successive iterations of a particular instruction. Then, the decoding of that instruction is used as a trigger to prefetch data from the memory location that is a stride-length away from the address from which data is presently needed.

In a software-based approach to prefetching, a main instruction stream is processed prior to run-time to identify instructions likely to cause a cache miss, to select a subset of the main instruction stream for computing the address of the data needed to prevent the cache miss, and to embed a trigger point in the main instruction stream for triggering the execution of the subset of the instruction stream in a separate thread from the main instruction stream. In this way, at run-time, the separate thread (a “helper thread”) is executed to prefetch the data and the cache miss is prevented.

### BRIEF DESCRIPTION OF THE FIGURES

The present invention is illustrated by way of example and not limitation in the accompanying figures.

FIG. 1 illustrates a system and a processor including logic for prefetching based on register tracking according to an embodiment of the present invention.

FIG. 2 illustrates an architected register tracker according to an embodiment of the present invention.

FIG. 3 illustrates a p-cache according to an embodiment of the present invention.

FIG. 4 illustrates a p-engine according to an embodiment of the present invention.

FIG. 5 illustrates a method of prefetching based on register tracking according to an embodiment of the present invention.

FIG. 6 illustrates a method of prefetching chaining based on register tracking according to an embodiment of the present invention.

### DETAILED DESCRIPTION

The following description describes embodiments of techniques for prefetching based on register tracking. In the following description, numerous specific details such as processor and system configurations are set forth in order to provide a more thorough understanding of the present invention. It will be appreciated, however, by one skilled in the art that the invention may be practiced without such specific details. Additionally, some well known structures, circuits, and the like have not been shown in detail, to avoid unnecessarily obscuring the present invention.

Embodiments of the present invention provide techniques for prefetching data, where data may be any type of information, including instructions, represented in any form recognizable to the data processing apparatus in which the techniques are used. The data may be prefetched from any level in a memory hierarchy to any other level, for example, from a main system memory to a level one (“L1”) cache, and may be used in data processing apparatuses with any other levels of memory hierarchy, between, above, or below the levels from and to which the prefetching is performed. For example, in a data processing system with a main memory, a level two (“L2”) cache, and an L1 cache, the prefetching techniques may be used to prefetch data to the L1 cache from either the L2 cache or main memory, depending on where the data may be found at the time of the prefetch, and may by used in conjunction with any other hardware or software based techniques for prefetching to either the L1 or the L2 cache, or both.

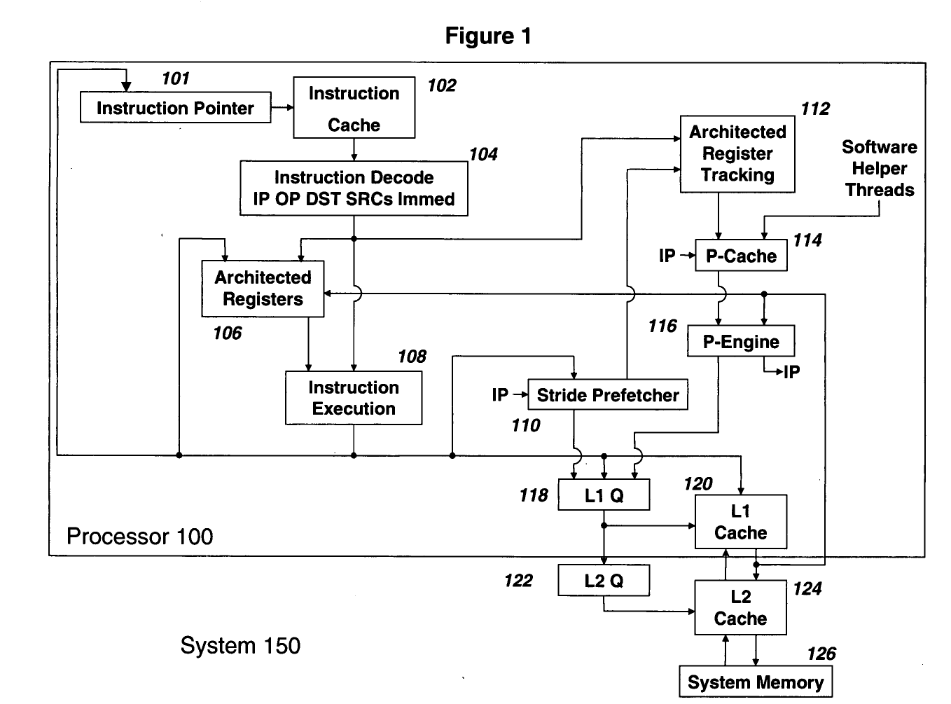

FIG. 1 illustrates an embodiment of a processor 100 including logic for prefetching based on register tracking. Processor 100 may be any of a variety of different types of processors, such as a processor in the Pentium® Processor Family, the Itanium® Processor Family, or other processor family from Intel Corporation, or any other general purpose or other processor from another company. Although FIG. 1 illustrates the invention embodied in a processor, the invention may alternatively be embodied in any other type of data processing component or apparatus. In the embodiment of FIG. 1, processor 100 includes instruction pointer (“IP”) 101, instruction cache 102, instruction decode unit 104, architected register file 106, instruction execution unit 108, stride prefetcher 110, architected register tracker (“ART”) 112, p-cache 114, p-engine 116, L1 request queue 118, and L1 cache 120. Other embodiments may differ, for example, another embodiment may include more than one instruction execution unit or p-engine.

Processor 100 is shown in FIG. 1 in system 150, an embodiment of a system including register tracking for speculative prefetching. In addition to processor 100, system 150 includes L2 request queue 122, L2 cache 124, and system memory 126. System memory 126 may be any type of memory, such as semiconductor-based static or dynamic random access memory, semiconductor-based flash or read only memory, or magnetic or optical disk memory. Processor 100, L2 request queue 122, L2 cache 124, and system memory 126 may be coupled to each other in any arrangement, with any combination of buses or direct or point-to-point connections, through any other components, or may be integrated in any combination into one or more separate components. System 150 may include any number of buses, such as a peripheral bus, or components, such as input/output devices, not shown in FIG. 1.

In processor 100, program flow is determined by instruction pointer 101. For example, instruction pointer 101 may be incremented to process instructions sequentially. Program flow may be redirected by executing a branch instruction to change instruction pointer 101. References to instructions or operations in this description may be to any instructions, micro-instructions, pseudo-instructions, operations, micro-operations, pseudo-operations, or information in any other form directly or indirectly executable or interpretable by processor 100, or any subset of such instructions or information.

To process instructions, instruction pointer 101 is used to access instruction cache 102. Instructions from instruction cache 102 are decoded by instruction decode unit 104 into an opcode (“OP”), a destination register designator (“DST”), one or more source register designators (“SRC”s) and an optional immediate (“Immed”) operand. The source register designators are used to read source register operands out of architected register file 106. Source register and immediate operands are sent, along with the opcode, to instruction execution unit 108.

Results from execution unit 108 may be written into architected register file 106, to the register designated by DST, or into L1 cache 120. To execution a load instruction, processor 100 calculates the load address, reads from that load address, and writes the data into architected register file 106, to the register designated by DST. Load and store requests from execution unit 108, along with prefetch requests from IP-based stride prefetcher 110 and p-engine 116, access the memory hierarchy via L1 request queue 118. Load, store, and prefetch requests that miss L1 cache 120 are forwarded to L2 request queue 122. These miss requests access data in L2 cache 124 or system memory 126, returning data to L1 cache 120 as needed. Load requests may also be used by IP-based stride prefetcher 110, according to any known approach, and ART 112, according to an embodiment of the present invention.

ART 112 uses load requests to monitor changes to registers that may be used to contain information for calculating an address of data in system 150. In this embodiment, ART 112 monitors changes to registers in architected register file 106 that may subsequently be used as base or index for memory accesses, such as, for example, the EBX and ESI registers, respectively, in the architecture of the Pentium® Processor Family. Other embodiments may include a temporary register, such as the EAX register in the architecture of the Pentium® Processor Family. In an embodiment where architectural registers are pushed onto and subsequently popped from the stack of an instruction stream or thread, any of a variety of known stack renaming mechanisms may be used to track changes to these registers.

ART 112 also generates pre-computation slices (“p-slices,” where a p-slice is a simple sequence of instructions to pre-compute a result that would subsequently be computed by a main sequence of instructions, where the simple sequence of instructions may or may not be a subset of the main sequence of instructions) based on changes to the contents of the base and index registers, or, in other embodiments, other registers. The p-slices may be used to calculate a memory address based on the contents of the register and to access that memory address, so that if that memory address is not presently accessible by accessing L1 cache 120, a prefetch of the data at or from that address to L1 cache 120 will occur. The address may be an address according to any approach for organizing memory in a data processing apparatus, for example, a physical address or a virtual address. The instruction in the main sequence of instructions that would otherwise cause an L1 cache miss is referred to as a “delinquent load” instruction.

These p-slices are stored in p-cache 114, along with associated trigger and target instruction pointers. In this embodiment, a p-slice may be associated with one or two trigger instruction pointers and one target instruction pointer. A trigger instruction pointer is the IP of a load instruction that loads the base or index register, and the target instruction pointer is the IP of a load instruction that first references the newly loaded base or index register.

The IP associated with each load request is also used to access p-cache 114. Any p-slices in p-cache 114 associated with this IP may be executed by p-engine 116 to prefetch the data. The target instruction pointers associated with these prefetch requests are then used, recursively, to access both p-cache 114 and IP-based stride prefetcher 110. Target instruction pointers of delinquent loads are the most valuable, as far as prefetching is concerned, but there are often several linked accesses between L1 cache misses. A single load instruction will typically trigger a sequence of p-engine prefetch requests and, possibly, one or more IP-based stride prefetch requests.

P-cache 114 may also be used to store p-slices or other instructions or operations generated by any other known approach. For example, p-cache 114 may store helper threads for prefetching according to any known technique, such as software-based prefetching, such that the helper threads may be executed by p-engine 116. P-cache 114 is not used to store p-slices for strided accesses in this embodiment, as prefetch requests from IP-based stride prefetcher 110 are sent directly to L1 request queue 118. However, an embodiment where p-cache 114 is used for strided accesses is possible within the scope of the present invention.

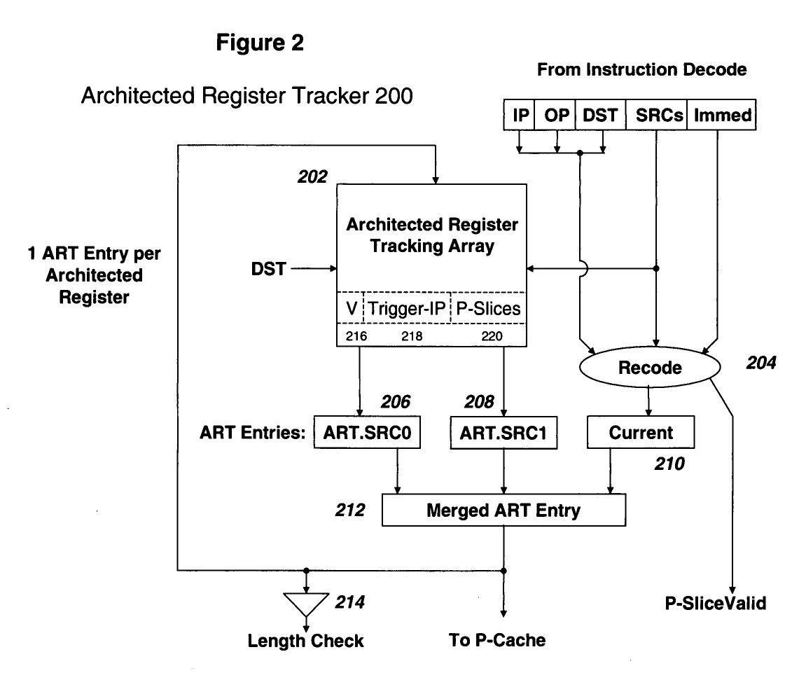

FIG. 2 illustrates ART 200 according to an embodiment of the present invention. ART 200 includes ART array 202, recode logic 204, and length checker 214.

ART 200 is coupled to an instruction decoder, such as ART 112 is coupled to instruction decode unit 104 in the embodiment of FIG. 1, to receive the OP, DST, SRC, and Immed fields from a decoded instruction. These fields are used by recode logic 204 to generate a p-slice and a p-slice valid indicator. In this embodiment, p-slice valid indicator is only set, or otherwise used to indicate that a p-slice is valid, for decoded instructions where the OP field may be recoded as a simple add, sub, shift, logical, load, or prefetch-conditional-end (prefetchCEnd) operation, or where the DST and SRC fields may be recoded as some form of a base address, plus an index (or shifted index) value, plus the value from the Immed field.

ART array 202 includes one entry per architected register. Each entry includes p-slice valid indicator field 216, trigger-IP field 216, and p-slice field 218 to hold one or more p-slice operations. Any decoded instruction that updates an architected register is also used to update the ART entry associated with that register. A load instruction clears p-slice field 218, sets p-slice valid indicator field 216, and enters the load instruction's IP in trigger-IP field 216 for the entry associated with the destination register. A move instruction copies the ART entry associated with the move instruction's SRC field to the ART entry associated with the move instruction's DST field.

For the remaining decoded instructions, the current p-slice 210 generated by recode logic 204 is appended to the existing ART entries 206 and 208, if any, associated with one or both of the decoded instruction's SRC fields (“SRC0” and “SRC1”) to generate merged ART entry 212. The IP from trigger-IP field 216 for ART entry 206 associated with SRC0 is used as for the trigger-IP field 216 for merged ART entry 212, unless SRC0 is null (i.e., SRC0 is not a valid architected register) or when the value in the decoded instruction's DST field equals the value in the decoded instruction's SRC1 field. P-slice valid indicator field 216 for merged ART entry 212 is the logical AND of the p-slice valid indicators for the current decoded instruction, ART entry 206 associated with SRC0 (unless SRC0 is null), and ART entry 208 associated with SRC1 (unless SRC1 is null), unless length checker 214 determines that there are more than a certain number (e.g., six) p-slices in merged ART entry 212, in which case p-slice valid indicator field 216 is reset. Merged ART entry 212 then replaces the ART entry associated with the current decoded instruction's DST field.

Recode logic 204 also detects whether certain types of compare-branch instruction pairs are used as either loop terminators or array index limit checks, and recodes these instructions with PrefetchCEnd operations and sets the p-slice valid indicator. In this special case, since compare or branch instructions do not normally update destination registers, whichever of the two source registers for the compare instruction was most recently used as an index register is used as the destination register to update ART 202.

If the current decoded instruction is a load instruction, merged ART entry 212 is also forwarded to a p-cache, such as p-cache 120 in the embodiment of FIG. 1. If a stride prefetcher, such as IP-based stride prefetcher 110 in the embodiment of FIG. 1, does not indicate that there is a stride match on the current load instruction, merged ART entry 212 is written into the p-cache. The load instruction's IP becomes the target-IP in the p-cache entry and the SRC0 and SRC1 trigger-IPs from merged ART entry 212 become the base-trigger-IP and the index-trigger-IP, respectively, in the p-cache entry, as described below.

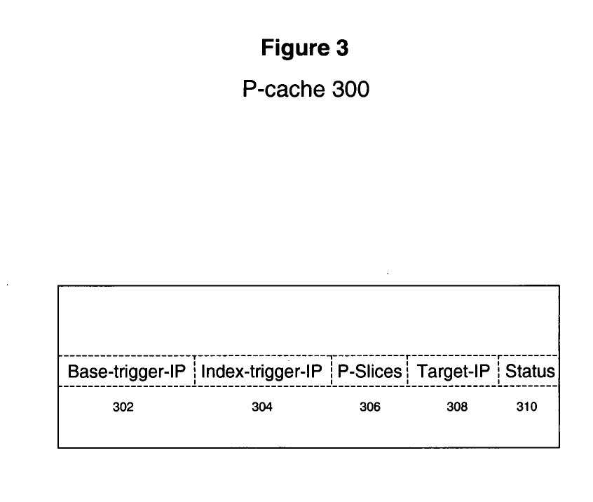

FIG. 3 illustrates p-cache 300 according to an embodiment of the present invention. P-cache 300 may be any size memory array. P-cache 300 is coupled to an ART, such as p-cache 114 is coupled to ART 112 in the embodiment of FIG. 1, to receive a p-cache entry. Each entry in p-cache 300 includes base-trigger-IP field 302, index-trigger-IP field 304, p-slice field 306 to hold one or more (e.g., six) p-slices, target-IP field 308, and status field 310 including an address length indicator (e.g., 32 or 64 bits) and an operand length indicator (e.g., 1, 2, 4, 8, or 16 bytes).

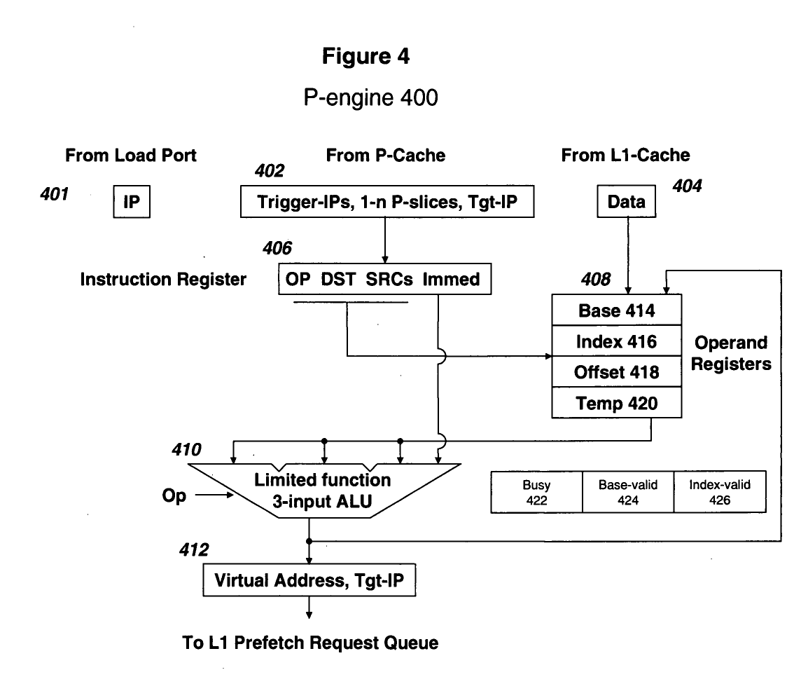

FIG. 4 illustrates p-engine 400 according to an embodiment of the present invention. P-engine 400 may be any circuit or logic to execute or interpret p-slices. For example, p-engine 400 may include a limited function three-input arithmetic logic unit to calculate a memory address from a base address, an index, and an immediate value. The use of p-engine 4000 to execute p-slices may be preferable to a software-based approach to prefetching that may require additional cores, logical processors, threads, or contexts to execute p-slices. A processor or computer system according to an embodiment of the present invention may include one or more p-engines.

In the embodiment of FIG. 4, p-engine 400 includes three-input arithmetic logic unit (“ALU”) 410, instruction register 406, and operand register file 408. Operand register file 408 includes base 414, index 416, offset 418, and temp 420 registers. P-engine 400 also includes several miscellaneous state fields including busy bit 422, base-valid bit 424, and index-valid bit 426. Other embodiments may differ, for example, in another embodiment a p-engine may include more than one instruction register, or two or more p-engines may share an ALU in much the same way that multi-threaded processors having separate architected registers for each thread share execution units.

P-engine 400 in coupled to a p-cache, such as p-engine 116 is coupled to p-cache 114 in the embodiment of FIG. 1, to receive a p-cache entry 402 on execution of each load instruction. If p-engine 400 is idle when it receives a new entry 402 from the p-cache, p-engine 400 initializes base register 414 or index register 416 as follows, and begins executing p-slices. If a load instruction's IP 401 (“load-trigger-IP”) matches the entry's base-trigger-IP, the data 404 returned by the L1 cache for that load instruction is used to initialize base register 414 and base-valid bit 424 is set. If load-trigger-IP 401 matches the entry's index-trigger-IP, the data 404 returned by the L1 cache for that load instruction is used to initialize index register 416 and index-valid bit 426 is set. For p-slices that use both base and index registers, base register 414 may be initialized first, but in another embodiment index register 416 may be initialized first.

As shown in the embodiment of FIG. 3, a p-cache entry 402 may include one or more p-slices (e.g., six). P-engine 400 retains an entire p-cache entry 402 until execution of all p-slices in the entry 402 is complete. Each p-slice is sent, in order, to instruction register 406.

P-engine 400 stalls if a p-slice accesses base register 414 and base-valid bit 424 is not set, or if a p-slice accesses index register 416 and index-valid index 426 is not set. This stall mechanism is used to handle the case of an L1 cache miss on the load instruction that initializes base register 414 or index register 416, and the case of base register 414 or index register 416 being required but not yet initialized.

Upon completion of the execution of all p-slices for a p-cache entry 402, busy bit 422, base-valid bit 424, and index-valid bit 426 are reset. If the last p-slice for the p-cache entry 402 is a PrefetchCEnd operation, p-engine 400 tests the loop ending or array index limit condition and loops back to the first p-slice for the p-cache entry 402 if the condition is not met.

P-engine prefetch requests 412 are only issued when p-engine 400 is able to run ahead of the processor core. If the load instructions are hitting the L1 cache, p-engine prefetch requests 412 are blocked. If the processor stalls, due to either an L1 or L2 cache miss, p-engine 400 begins to issue prefetch requests 412 for recently issued load instructions that hit in the p-cache. Similarly, if subsequently completed load instruction has an IP 501 matching the target-IP associated with instruction register 406, p-engine 400 is reset.

P-engine prefetch requests 412 may be chained. Each p-engine prefetch request 412 has a target-IP associated with it from its p-cache entry 402. When the p-engine prefetch request 412 completes (i.e., data is returned), its target-IP is used to access the p-cache. Any p-cache entries whose base-trigger-IP or index-trigger-IP match the target-IP of prefetch request 412 will be sent to p-engine 400 (or any available p-engine in an embodiment having multiple p-engines) for execution.

Since, as described above, p-engine prefetch requests 412 are associated with a target-IP, p-engine prefetch requests 412 may be used to access a stride-filtering mechanism, a p-cache, and a p-engine in the same manner as a load instruction.

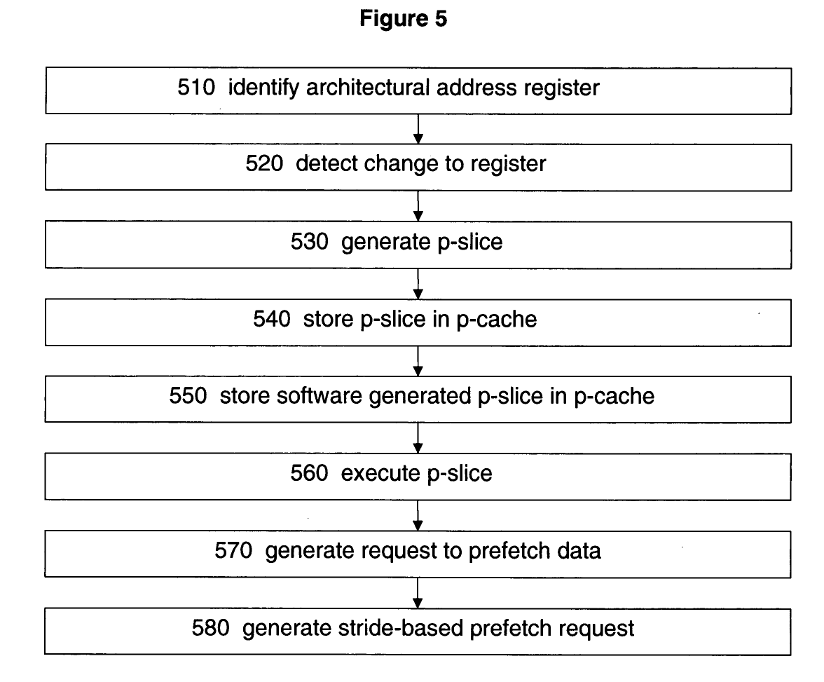

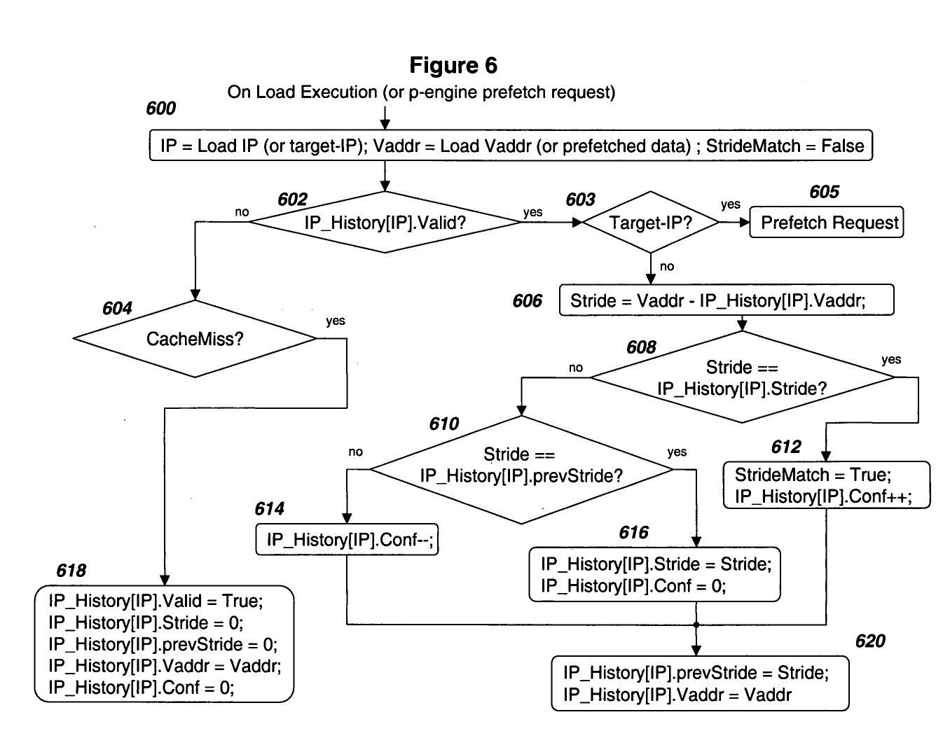

FIG. 5 is a flowchart illustrating an embodiment of the present invention in method 500 for prefetching based on register tracking. In block 510, a register that may be used to contain information for calculating an address of data is identified. In block 520, a change to the contents of the register is detected. In block 530, a p-slice is generated based on the contents of the register. In block 540, the p-slice is stored in a p-cache. In block 550, a software-generated p-slice is stored in the p-cache. In block 560, the p-slice generated based on the contents of the register is executed by a p-engine. In block 570, the execution of the p-slice results in generating a request to prefetch data to an L1 cache. In block 580, the execution of the p-slice results in generating a stride-based prefetch request, for example, as described below with respect to FIG. 6.

FIG. 6 is a flowchart illustrating an embodiment of the present invention in method 600 for prefetching based on a known IP-based stride approach, modified to interoperate with a register tracking approach to include prefetch chaining. In block 600, IP and address values are initialized based on the IP and the load address of a currently executing load request, or for prefetch chaining, based on the target-IP of a p-engine prefetch request and the data returned (typically a base address).

In block 602, an IP-history associative array is checked to determine if an entry exists for the current IP value. If an entry does not exist, flow proceeds to block 604. If the load request encounters a cache miss in block 604, then in block 618, a new entry is created and initialized in the IP-history array. If the load request does not encounter a cache miss is block 604, no new entry is created.

However, if in block 602, an entry already exists for the current IP value in an IP-history associative array, flow proceeds to block 603. From block 603, if the IP-history array match is based on a target-IP of a p-engine prefetch request, then, in block 605, a stride-based prefetch request is triggered. The triggering of a prefetch request in block 605 may be qualified based on the confidence field in the IP-history array entry. The IP-history array is not updated based on p-engine prefetch requests.

From block 603, if the IP-history array match is not based on a target-IP of a p-engine prefetch request, then, in block 606, the stride is calculated based on the current and previous address values in the entry for the current IP value. Then, in block 608, the calculated stride is compared to the current stride value in the entry for the current IP value. If it matches, then in block 612, the confidence field in the entry for the current IP value is updated and a stridematch indicator is set. The stridematch indicator is sent to an L1 request queue to generate one or more prefetch requests, and is also sent to a p-engine to remove strided accesses from a p-cache. Strided access patterns are not included in the p-cache and load instructions with a known, constant stride do not access the p-cache or the p-engine, which may reduce p-cache size and increase overall prefetch effectiveness. From block 612, in block 620, the address and previous stride values in the entry for the current IP value are updated.

If, however, in block 608, the calculated stride does not match the current stride value in the entry for the current IP value, then, in block 610, the calculated stride is compared to the previous stride value in the entry for the current IP value. If it matches, then, in block 616, the stride for the current IP value is updated and the confidence field is cleared. Then, in block 620, the address and previous stride values in the entry for the current IP value are updated.

Within the scope of the present invention, methods 500 and 600 may be performed in a different order, with illustrated blocks omitted, with additional blocks added, or with a combination of reordered, combined, omitted, or additional blocks. For example, in method 500, block 550 may be omitted in an embodiment where software generation of p-slices is not used. Furthermore, embodiments of the present invention may be applied to add prefetch chaining to any type IP-based prefetching and their application is not limited to IP-based prefetching according to method 600.

Processor 100, or any other processor or component designed according to an embodiment of the present invention, may be designed in various stages, from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these mediums may “carry” or “indicate” the design, or other information used in an embodiment of the present invention, such as the instructions in an error recovery routine. When an electrical carrier wave indicating or carrying the information is transmitted, to the extent that copying, buffering, or re-transmission of the electrical signal is performed, a new copy is made. Thus, the actions of a communication provider or a network provider may be making copies of an article, e.g., a carrier wave, embodying techniques of the present invention.

Thus, techniques for prefetching based on register tracking are disclosed. While certain embodiments have been described, and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising:
a register tracker to generate a pre-computation slice; and
a pre-computation engine to execute the pre-computation slice.

2. The apparatus of claim 1, further comprising a cache, wherein the pre-computation engine is to execute the pre-computation slice to generate a first prefetch request.

3. The apparatus of claim 2, further comprising a stride prefetcher, wherein the stride prefetcher is to generate a second prefetch request based on the first prefetch request.

4. The apparatus of claim 1, further comprising a pre-computation cache to store the pre-computation slice between generation and execution.

5. The apparatus of claim 4, wherein the pre-computation cache is also to store a software-generated pre-computation slice.

6. The apparatus of claim 1, further comprising a register to store a portion of an address, wherein the register tracker is also to track changes to the contents of the register.

7. The apparatus of claim 6, wherein the register tracker is to generate the pre-computation slice in response to a change in the contents of the register.

8. A method comprising:
detecting a change to the contents of a register; and
generating a pre-computation slice based on the contents of the register.

9. The method of claim 8, wherein the register is to store information for calculating an address of data.

10. The method of claim 8, further comprising storing the pre-computation slice in a pre-computation cache.

11. The method of claim 10, further comprising storing a software-generated pre-computation slice in the pre-computation cache.

12. The method of claim 8, further comprising executing the pre-computation slice.

13. The method of claim 12, further comprising prefetching data as a result of executing the pre-computation slice.

14. The method of claim 12, further comprising generating a stride-based prefetch request as a result of executing the pre-computation slice.

15. A system comprising:
a memory;
a processor including:
a cache;
a register tracker to generate a pre-computation slice; and
a pre-computation engine to execute the pre-computation slice to cause data to be prefetched from the memory to the cache.

16. The system of claim 15, wherein the processor also includes a register to store a portion of the address of the data in the memory, and wherein the register tracker is also to track changes to the contents of the register.

17. The system of claim 16, wherein the register tracker is to generate the pre-computation slice in response to a change in the contents of the register.
